(19) United States
(12) Patent Application Publication
(10) Pub. No.: US 2020/0144442 A1
(43) Pub. Date: May 7, 2020

(54) METHOD FOR MANUFACTURING A HOLLOW BUILDING PANEL WITH INTEGRATED PHOTOVOLTAIC CELLS

(71) Applicants: Arkadi BABAJANYAN, Kyiv (UA); Arshak BABADZHANIAN, Kyiv (UA)

(72) Inventors: Arkadi BABAJANYAN, Kyiv (UA); Arshak BABADZHANIAN, Kyiv (UA)

(21) Appl. No.: 16/624,961

(22) PCT Filed: Jun. 20, 2018
(86) PCT No.: PCT/UA2018/000061

§ 371 Date: Dec. 20, 2019

(30) Foreign Application Priority Data
Jun. 23, 2017 (UA) A 2017 06462

(51) Int. Cl. H01L 31/18; H02S 20/24; H02S 20/25; H02S 20/26; H02S 30/10

(52) U.S. Cl. CPC H01L 31/186; H02S 20/24; H02S 30/10; H02S 20/26; H02S 20/25

(57) ABSTRACT

The invention relates to construction, in particular to a method for producing hollow building panels with integrated photovoltaic elements for flat and sloping roofs and also for building facades. What is claimed is: a method for manufacturing hollow building panels with integrated photovoltaic elements, and also a hollow building panel manufactured according to said method. The claimed hollow building panel with integrated photovoltaic elements comprises a front translucent plate with photovoltaic elements, and a rear rigid supporting plate of equivalent size, said plates being held together along the outer edge by a spacer frame made from a moisture-impermeable polymeric sealant with adhesive properties, and aluminium or polymeric strips. Furthermore, continuous and/or discrete spacer walls made from a moisture-impermeable polymeric sealant with adhesive properties and aluminium or polymeric strips are mounted between the front plate and the rear plate along the perimeter or part of the perimeter of each photovoltaic element or group of photovoltaic elements.

The invention relates to construction, in particular to a method for constructing roofing building panels for flat and sloping roofs and facades of buildings with integrated solar photovoltaic (PV) cells and/or collectors.

Integrated photovoltaic building materials are used for replacement of regular building materials in various enclosing structures of buildings and facilities such as roof, windows and facades and have been a high-growth field of green building industry in the recent decade [1]. The advantage of the integrated systems over the non-integrated systems, in addition to optimization of area for collecting solar energy, is a considerable reduction of initial costs and estimated costs of construction/repair. In addition, since integrated building structures are an integral part of a building or a facility, they are better consistent with the architectural appearance of a building and are more aesthetic than conventional solar (PV) modules.

Considering presence of high wind loads on the roof, (PV) modules have small surfaces (about 2 m²), while building structures with photovoltaic cells may be produced in large dimensions and may be subject to high requirements for its strength characteristics in order to carry people, materials and to resist heavy wind loads for facade structures.

Standard PV modules themselves cannot serve as roofing covering since PV-cells integrally encapsulated with double EVA film with a front glass do not withstand deformations of tempered glass even under light loads on its surface.

Integrating amorphous or thin-film photovoltaic cells in building structures is not observed here (albeit their use in the invention is not ruled out) considering their short operating time equaling 10 years only, being inconsistent with the timespans of building structures, and due to a very low efficiency of converting solar radiation into electric power, which stands at 7-8%, which is 2-3 times lower than that of silicon mono and polycrystalline PV-cells with an operating time of 25-30 years.

Prototypes of the method for manufacturing roofing solar panel with or without integrated PV-cells combining functional capabilities and structural external appearance are not available. Hybrid solar battery (air-PVT) have functional capabilities of generating electrical and heat energy at the same time, but in no way can be considered as building coverings owing to the fact that it is impossible, as with PV modules, to provide for strength characteristics of the covering due to the presence of PV-cells on the front side and of an absorber in the cavity of the collector.

[2] should be classified among the analogues having close external appearance, in addition to up-to-date PV modules of “glass-glass” type, i.e. PV-cells encapsulated with EVA film between two tempered glasses (decorative triplex or “sandwich”), which are not a building structure, but are used as a roof covering. Such PV modules of “glass-glass” type (of Russian company “Hevel”, Latvian company “Soli Tek”, Japanese company “Solar Frontier” etc.) withstand a pressure up to 5 kPa under a special structure of the base from aluminium false roof for ventilation; in the event that additional supporting aluminium profiles are installed the strength characteristics may increase. In [2] the hollow solar building panel is a glass-metal unit of small dimensions made of a front transparent glazing sheet with solar elements affixed by means of silicone rubber, connected in series-parallel way to each other, and with output buses with blocking diodes and sealed contacts installed on the back supporting metal plate. The transparent sheet and the supporting metal plate are hermetically fixed together from inside along the periphery by means of an adhesive tape with a spacer frame filled with moisture-absorbing molecular sieve, a sealed chamber with a dried air cavity being formed between the sheet and the plate. Butt ends of the glass-metal unit are treated with a moisture-impermeable vulcanizing sealant and can be inserted into aluminium profiles of the window system compatible with the elements of a facade system of spatial aluminium building structures. The metal plate is fitted with heat removal finning in order to increase heat exchange efficiency. The shortcoming of the invention is poor heat transfer due to the panel's hermeticity and due to the panel being costly with use of a finned metal supporting base.

The object of the invention [3] is to provide a method for manufacturing solar roofing coverings integrated into a structural element of the panel supporting base ensuring bringing strength and service life of the assembly up to the level of the main material of the supporting base of the article. The stated object is achieved through the roofing panel, which comprises a supporting base (including in the form of curved surface, for instance, of a type of roofing tile) and PV-cells with a current-collecting cable, having at least one flat platform embedded relative to the upper surface of the base to a depth of 20 mm, where PV-cells with electrical cable are laid. PV-cells are poured over up to the upper surface of the base with a sealing curing system with a level of light transmission of at least 30% of the available maximum level of light radiation within the operating range of solar batteries (air-PVT). The shortcoming of this invention is poor heat exchange and a very low light transmission due to the presence in the plate over PV-cells of a thick layer of curing system and/or glass with a thickness of 18 mm, which are required for uniform distribution of the strength characteristics of the supporting base over the entire surface.

Among common shortcomings of the analogues one should mention a considerable drop in the efficiency of PV-cells as temperature rises during their operation due to inadequate heat exchange of the latter with the environment. Exceedance of the temperature range is the result not only of direct solar radiation but also of heat released by PV-cells during operation of PV modules, reaching up to 75° C. and more (the temperature coefficient close to −0.5 at standard PV modules is always indicated under 25° C. according to STC test), which leads to a considerable decrease in the converting efficiency factor of PV-cells up to 25% and more. In addition, rise in the temperature range accelerates PV-cells degradation.

Among the analogues having similar functional capabilities in terms of heat exchange one could mention hollow roof ceramic roofing tile [4] produced since 2006 by company Solarcentury, which converts solar energy into both electrical and heat energy. Such hollow roofing tile allows for heat energy released by PV-cells to be extracted by a heat-carrying agent and significantly increases their efficiency. Among the shortcomings of solar hollow roofing tile one should mention its small dimensions and a considerably lower capability for extraction of solar radiation from a unit of covered area to convert into electrical energy. For instance, a solar plant from standard PV modules needs about 6 sq. m. of roof area per each kilowatt, whereas a solar plant from roofing tile with PV-cells even with solar concentrators [5] needs 12-13 sq. m., which is of importance in the event of initial limitedness of construction. In addition, roofing tile can be used only for inclined roofs.

In [6] special building plates for inclined and flat roofs made of synthetic materials, metal, metal alloys or their combinations allowing for a structure of larger dimensions than hollow ceramic roofing tile with PV-cells have been developed. The plates have a complex structure requiring assembly and their gluing together to form a single piece from various specially cast or formed elements, with a supporting surface comprising the top and bottom clamps and stiffening ribs. By adding hollow structures with inlet and outlet for a heat-carrying agent to the rear side of the plate the plates are used as a heat collectors and/or as air-PVT collectors in the event of presence of through rectangular cutouts in the plate by adding there inserts from one or more PV-cells covered with a transparent material. Among the shortcomings, in addition to the structure complexity and its being costly, as with hollow roofing tile, one should mention a considerably lower capability for extraction of solar radiation from a unit of area for PV-cells and, consequently, a need for heat extraction at the same time to use the plate surface in the optimum way.

An ordinary water solar collector for transfer of heat to the hot water supply system which is at the same time an element of the roof building structure is described in [7]. The solar collector for water heating consists of two metal sheets welded together, an upper one and a lower one stamped with corrugations or with round indentations for spot welding of the sheets together and four threaded sleeves welded to the lower sheet which enables to pump a sufficient amount of water through slot-like cavities between the sheets, for connection with pipelines in a hot water supply system. The sheets are welded together along the periphery and by spot welding over corrugations or round indentations, the upper sheet having wave profiles on the edges, which allows for using each collector as a roofing module, the screen (the upper sheet) of each collector being covered with a selective covering. Given that the present solar collector is close in terms of structure to regular room metal heating batteries, the use of the invention on a roof is doubtful from considerations of reliability and life time of the metal built-up structure.

The purpose of the present invention is a method for manufacturing building hollow panels of an arbitrary size with integrated PV-cells or without them to produce electrical and heat solar energy (IBSHPs) for flat and inclined roofing and building facades. The technical result of the present method is to provide IBSHPs for various purposes, withstanding heavy loads, namely, weight of the individuals and materials for roof panels and wind loads for facade glass panels as well as to increase the efficiency of converting solar energy and life time of PV-cells by means of:

a) a maximum increase in light absorbing capacity of PV-cells by decreasing the thickness of the front side of IBSHP;
b) a possibility of providing various hollow panels with an optimum arrangement of heat rejection, wherein operating efficiency of PV modules increases by more than 20%, which is commensurate with the purpose of new technological research in solar power;
c) a possibility of defrosting mode in winter time, i.e. In the event of presence of snow and ice on the surface of IBSHP in the morning, short-time supply of warm air to the cavity to start operation of PV-cells;
d) a possibility of extraction of the most part of solar energy as heat energy for its further use.

The method enables to considerably simplify and make cheaper manufacturing IBSHPs and without additional expenses during manufacturing SBs to produce at the same time solar collectors as well.

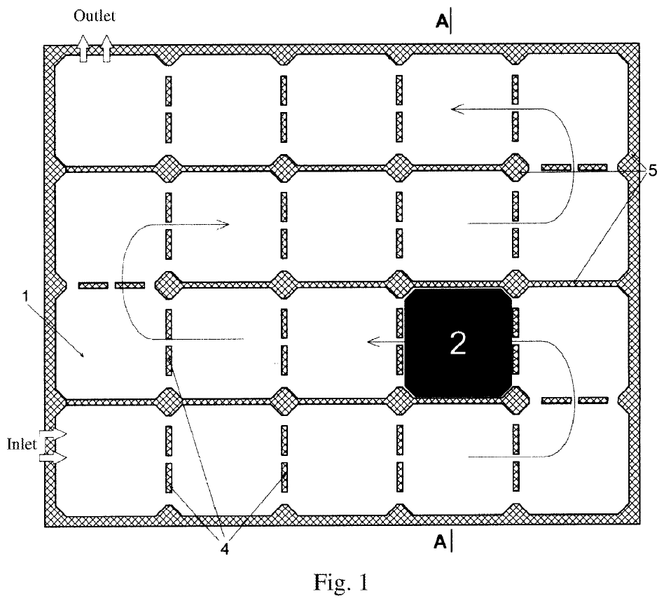

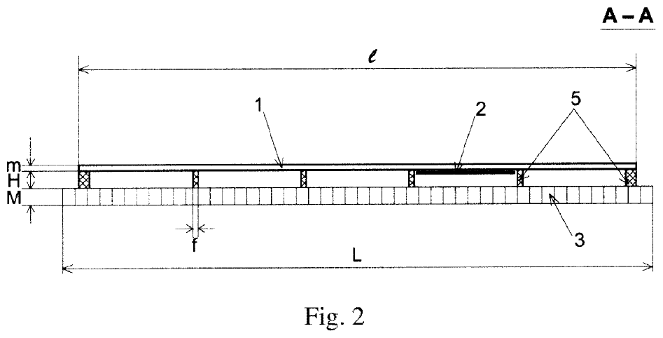

Providing IBSHP with a large surface envisages high strength characteristics (rigidity) of the panel. The present method of providing IBSHP as a rigid unit made of a sheet of front translucent material of any dimension (glass or transparent material, coloured one is possible for facade panels) with PV-cells and a back rigid plate (asbestos board, metal and alloys, synthetic materials, tempered glass) envisages imparting the rigidity of the back side to the front side by providing polymeric and/or metal spacer walls attached with a sealant with high adhesion uniformly over the entire surface between the front and the back sides along the perimeter of each PV-cell or group of PV-cells in the distances between PV-cells, not only along the periphery of the unit. In addition, additional and greater rigidity is provided by the structure being of beam-type, which depends on the unit thickness and an overall jointing area of spacer walls. Resulting IBSHP is a hollow unit-beam or a hollow panel composed of a sheet of front transparent material of any dimension such as tempered glass and glass not being tempered glass or transparent plastic 1 (FIG. 1, 2) with PV-cells which are hermetically attached, possibly by laminating, and electrically connected on it in series-parallel way within slots 2 (FIG. 1, 3) and the back rigid plate such as asbestos board, metal or rigid synthetic materials 3, possibly of larger dimensions, that is L> [symbol] along the length and\or along the width (FIG. 2). PV-cells are hermetically sealed together with electrically conductive contacts which are additionally covered with polymeric paint or originally laminated with EVA film for them to be fully hermetically sealed against adverse effects of various climatic factors. Hereinafter a flat asbestos board with a thickness of M=6-12 mm (FIG. 2) which is a readily available and non-expensive material with high strength characteristics (bending strength 20-50 MPa, compression strength 90-130 MPa), is frost-resistant (following 50 cycles of frosting-defrosting the sheets lose no more than 10% of their strength) and is practically water-proof by 100% is taken as a rigid plate. Tempered glass or glass not being tempered glass of a required thickness of m is taken as a front material. The sheets of glass and asbestos board (“glass-asbestos board” unit) are fixed together from inside with one- or two-component polymeric sealing glue (silicone, polyurethane or MS-polymeric), similarly to window glass units, not only along the periphery as a spacer frame, but also over the entire surface of the glass along the perimeter or along a part of the perimeter of each PV-cell or groups of PV-cells by means of spacer walls with a width of f, which is not larger than the distance between PV-cells (FIG. 2). Actually, solar batteries from the “glass-asbestos board” unit are converted into a hollow panel of beam-type structure or a hollow panel of “glass-asbestos board” type i.e. IBSHP, due to an increase in the rigidity of glass of solar batteries by providing discrete 4 (FIG. 1, 4) and/or continuous 5 (FIG. 1, 3, 4). Strength characteristics of the manufactured IBSHPs reach tens and hundreds of MPa and are only limited to the strength of supporting structures of a roof or facades since pressure on the surface of tempered glass is uniformly transmitted through spacer walls to an abutment surface of asbestos board and further to the structures of a house roof or facades.

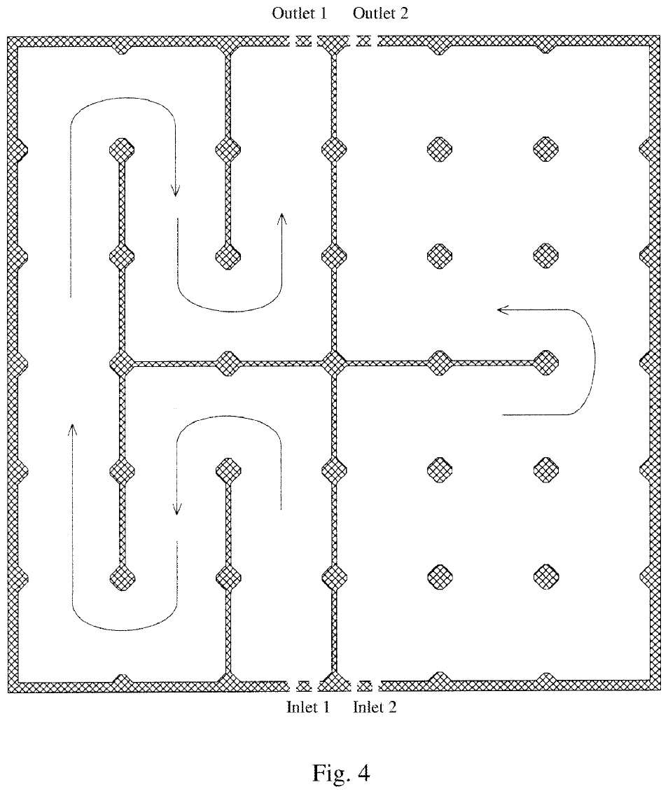

Depending on intended use of IBSHPs, an overall length, width and geometry of spacer walls (for instance, FIG. 1-4), as well as thicknesses m and M for glass and asbestos board and a distance H (FIG. 2) between them are selected. The rigidity of «glass-asbestos board» beam-type unit can increase thanks to the width of the spacer wall f i.e. a distance between PV-cells (from several millimetres to 10-15 mm and more) and an overall length, i.e. an overall area of contact of the spacer wall with asbestos board and with glass.

This makes it possible to decrease the thickness of tempered glass (for instance, up to m=1 mm for roofing IBSHPs), which increases light permeability and, consequently, increases converting efficiency of PV-cells and reduces the cost at the same time. To put this into perspective, it will be reminded that in standard PV modules, the surface of which does not exceed 2 sq. m., tempered glass with a thickness above 3 mm is used, and in facade structures its thickness is over 6-10 mm, which is necessary for wind loads of large surfaces.

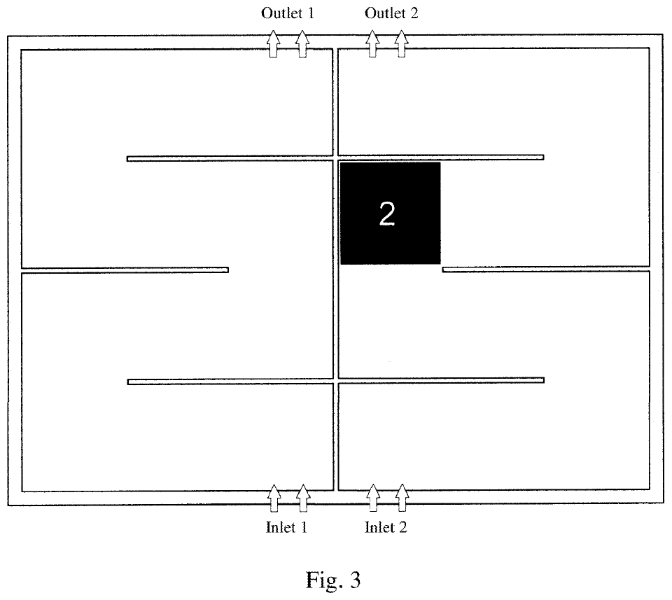

Spacer walls may have different geometry of slots for mono- (for instance, FIG. 1, 4) or polycrystalline PV-cells (FIG. 3) and different dimensions for PV-cells (for instance, 78×78 mm, 156×78 mm, 156×156 mm or other). Spacer geometry itself also influences the thickness of the used tempered glass and glass not being a tempered glass or transparent or coloured plastics substituting glass.

In addition, one can use in IBSHPs not only thinner tempered glass, but also glass not being a tempered glass (for instance, for PV-cells dimensions of 156 mm×156 mm a sufficient thickness m=4 mm), in view of the fact that when glass breaks down squares of glass that break off will be of small dimensions (smaller than a dimension of the slot), while most of the pieces of broken glass will be retained by the polymer of the walls due to their high adhesion.

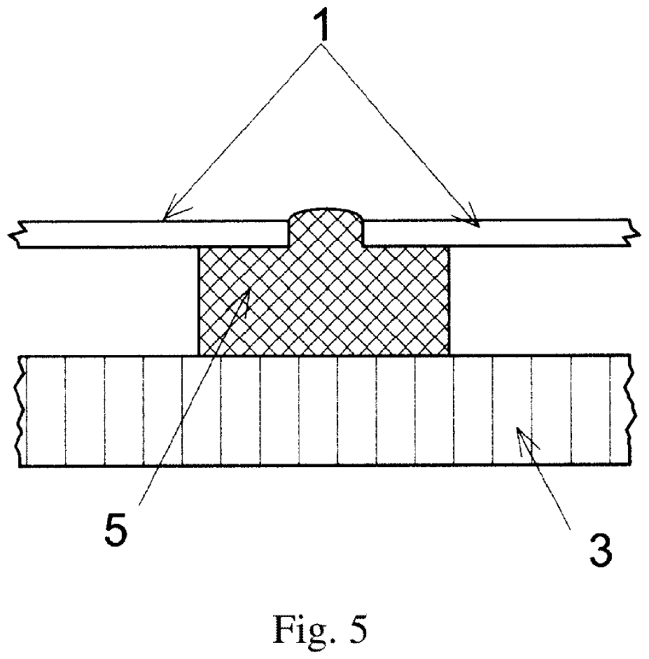

The present method allows for a single-piece glass to be replaced with the parts joints of which fall at the spacer walls with their widths f being slightly increased in this part (up to 15-40 mm), as depicted in FIG. 5, which considerably reduces the cost of IBSHPs. This enables to provide IBSHPs with a front surface exceeding the dimensions of the glass produced in the industry, which, if thickness is 1-2 mm, a priori cannot have large dimensions. In addition, in ISBHPs for facades without PV-cells, i.e. used as flat air collectors only, a set of ceramic tiles, which are originally of small dimensions, in a similar way can be used as a front covering.

For IBSHPs without PV-cells used for extracting heat energy only the front side may be non-transparent in the first place (a metal sheet, thin-wall clay, ceramic or other material), while selective painting of the front side or an aluminium or a copper sheet with a thickness of 0.2-0.5 mm attached from the inside and the front metal or ceramic tiles themselves serve as absorbers instead of PV-cells.

Hereafter and in the claims, front translucent side with PV-cells is to be understood as glass with hermetically affixed or laminated and electrically switched photovoltaic cells or double glass with PV-cells which are encapsulated between them and electrically switched similarly to up-to-date PV modules of “glass-glass” type mentioned above as “sandwich” [8]. In both cases the use of double-sided PV-cells, i.e. PV-cells with two light-absorbing sides (bifacial) is not excluded. Light transmission and scattering within the cavity of IBSHPs with double-sided PV-cells are provided for by spacer walls with a transparent sealant and transparent spacer strips.

The present method for constructing hollow IBSHPs enables to considerably increase the efficiency of operation of PV-cells by forced creation of airflow in a “glass-asbestos board” cavity for fast and uniform heat rejection (FIG. 1, 3, 4) through a contact of the heat-carrying agent (air) with PV-cells.

The distance H between glass and asbestos board, i.e. the height of spacer polymer walls may be from 5 mm to 30 mm and more to meet the requirements for air exchange velocity which, above all, depends upon the climatic conditions of the region. Based on this fact it is to be noted that per 100 sq. m. of the surface of IBSHPs (i.e. for a 15 kW solar plant) it is necessary to provide for air exchange with a volume from 0.5 cubic meters to 3 cubic meters, which will not require special expenses.

In winter time to remove snow and ice from IBSHPs, which is a hardest task for standard PV modules, it is possible to provide a “defrosting mode” i.e. initial short-time hot air injection to the panel cavity in order to initiate operation of PV-cells, which will be conducive to a proper output of IBSHPs and have an effect on an overall operation efficiency of the solar plant during the entire winter period.

Depending on structural and arrangement features and technical and economic practicability of the constituent elements implementing the present technical solution (for instance, use of mono- or polycrystalline PV-cells, glass being or not being a single piece, thickness of glass and asbestos board, glass colour for a case of facade panels, their dimensions and the like) various options of IBSHPs are possible with due regard for the explanations, FIG. 1-6.

In the event that a liquid heat-carrying agent is used in the cavity of IBSHP, a polymeric sealant resistant to active media is to be used.

Another option of technical solution by means of the present method is to manufacture PV modules as a beam-type unit with a non-hermetic structure of the cavity, in the latter case holes are made for natural air exchange on the back side. Such a beam-type unit has higher strength characteristics compared to a frame supporting aluminium structure of standard PV modules, which in this case can be replaced with a decorative plastic profile.

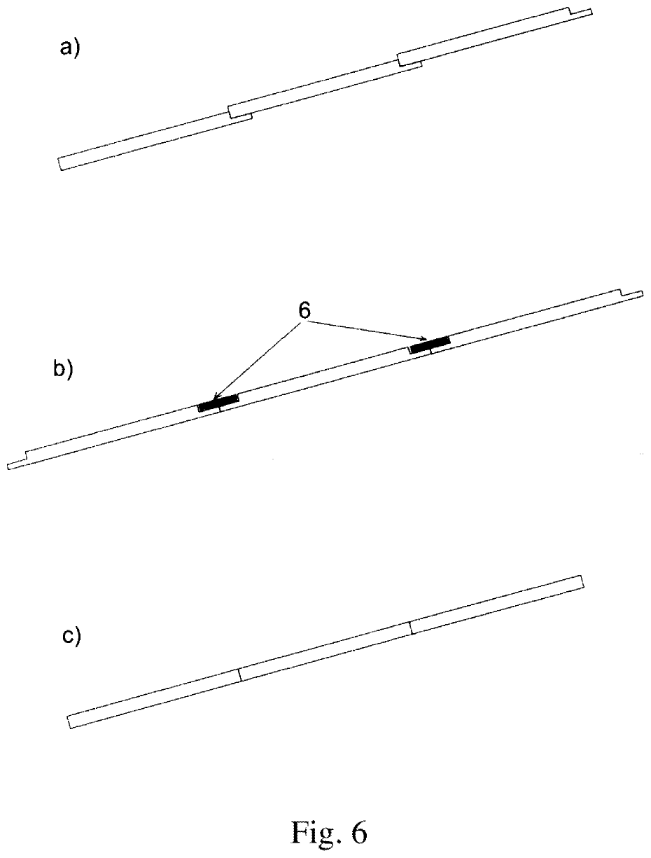

IBSHPs are laid over the entire covered area by a series and/or a parallel connection of inputs and outputs located in the butt ends of IBSHPs (FIG. 1, 3, 4) or its back side for an arrangement of forced or natural heat exchange and it is schematically shown with respect to an inclined roof in FIG. 6a, b, with respect to a flat roof in FIG. 6b, c (in FIG. 6b an additional insertion of asbestos board or other insulation on a sealant is designated as 6).

The panels are mounted and joined on a wooden or other base of a roof by means of T-shaped fasteners-clamps in pairs on asbestos board of the adjacent panels with a free-play for a subsequent levelling of the entire roof plane and for closing joints with the same sealant. The facade surface can be assembled according to the diagram shown in FIG. 6c or further in the structure of IBSHPs the elements of aluminium profiles compatible with the elements of a facade system of spatial building aluminium structures can be used.

Indication of specific numerical values in the text is aimed at explaining the description and drawings and in no way limits the claims.

FIG. 1-6

1. A method for manufacturing a solar battery and converting it to the elements of building structure, according to which a hollow unit made of a front translucent side with photovoltaic cells and a back supporting rigid plate of an equal or larger dimension fixed together hermetically from inside along the periphery of the front side by means of a spacer frame made from a moisture-impermeable polymeric sealant with adhesive properties and aluminium or polymeric strips is transformed, characterized in that continuous and/or the same discrete spacer walls are provided between the surfaces of the front side and the back plate along the external periphery of the perimeter or a part of the perimeters of each photovoltaic cell or groups of photovoltaic cells, which transform the unit with photovoltaic cells into a hollow building beam-type panel.

2. The method for manufacturing a solar battery and converting it to the elements of building structure of claim 1, wherein the geometry of the spacer walls has been designed to arrange uniform and controlled heat exchange from the entire volume of the panel cavity by providing one or more parallel and independent cavities through inlets and the corresponding outlets on the lateral sides or the back side.

3. The method for manufacturing a solar battery and converting it to the elements of building structure with a front translucent side comprising double-sided photovoltaic cells of claim 1 and claim 2, wherein the spacer walls are transparent.

3′ A building solar hollow panel manufactured according to the method of claims 1 and 2 with a front translucent side comprising double-sided photovoltaic cells, wherein the spacer walls are transparent.
